(19) United States
(12) Patent Application Publication
(10) Pub. No.: US 2012/0292066 A1
(43) Pub. Date: Nov. 22, 2012

(54) PNEUMATIC TOOL HAVING PENDULUM-LIKE DIRECTION SWITCHING MECHANISM

(76) Inventors: Chih-Ming TING, Taichung City (TW); Yen-Che CHIANG, Taichung City (TW)

(21) Appl. No.: 13/339,902

(22) Filed: Dec. 29, 2011

(30) Foreign Application Priority Data
May 20, 2011 (TW) 100209155

(51) Int. Cl. B25B 21/02; B25D 17/00; B25D 9/12

(52) U.S. Cl. 173/104; 173/221

(57) ABSTRACT

The pneumatic tool having pendulum-like direction switching mechanism of the present invention includes a pneumatic motor and a control valve. The control valve is utilized for receiving pressurized air and for alternatively leading air into the pneumatic motor to drive and control the pneumatic motor. The present invention further includes a switching device and a coupling mechanism. By connection of the coupling mechanism, the switching device is able to control motion of the valve. In addition, the switching device slides along an arc-shaped route. Thus, the switching device approaches the pneumatic tool without protruding excessively. Therefore, unexpected collision is lessened and lifetime is prolonged.

### BACKGROUND OF THE INVENTION

1. Field of the Invention

The present invention relates to a pneumatic tool having direction switching mechanism.

2. Description of the Prior Art

Conventional pneumatic tool has pneumatic motor which is driven by pressurized air. Rotor of the motor is rotated by air, driving tool to rotate, so that detachment and attachment of bolts can be processed smoothly. For implementing detachment and attachment operation, most of conventional pneumatic motors are produced with switch devices thereon. For instance, pneumatic tools provided in patents, TWM396733, TWM370470, TWM293124, and TWM284504, are all equipped with similar switch devices. In these pneumatic tools, the switch devices are operated to switch a control valve, interchanging pathways of pressurized air, and rotation direction of the rotors is then changed.

However, as mentioned in TWM293124, most of the pneumatic tools can not be utilized easily since shifting of the switch device has to be implemented by two hands. To overcome the disadvantage, TWM293124 provides a pneumatic tool which can be operated by single hand in shifting switch device. Unfortunately, the pneumatic tool provided is produced with two control valves. As a result, complexity and cost of the pneumatic tool are raised, and the structure is difficult to be applied to other tools.

As mentioned in TWI319346 and U.S. Pat. No. 7,594,549, another pneumatic tool is provided with a rod which can move horizontally. By moving the rod, the control valve is rotated, so that rotation direction of the rotor of the pneumatic motor is changed. In addition, the rod is capable of being shifted by single hand easily.

However, the pneumatic tool provided in TWI319346 and U.S. Pat. No. 7,594,549 still has several disadvantages in practical using. Firstly, the rod is able to be pressed and moved horizontally. Thus, the rod would considerably protrude out from the shell of the pneumatic tool. The rod would probably be hit and shifted by surroundings. As a result, users have to utilize the pneumatic tool carefully to prevent the rod from unexpected switching, especially in narrowed space. Secondly, lifetime of the rod and the control valve would be shortened since the rod would be stroke easily, even frequently. In addition, the rod and the valve would be abraded seriously since the rod may be shifted and switched frequently. Cost of renovating the rod and the valve would considerably high.

In addition, pneumatic tool described in patent U.S. Pat. No. 8,020,631 is provided with switch device, also. However, the switch device is designed just as the switch devices mentioned above, two-hand operation is necessary or unexpected strike goes frequently. The disadvantages are not solved by U.S. Pat. No. 8,020,631.

The present invention is, therefore, arisen to obviate or at least mitigate the above mentioned disadvantages.

### SUMMARY OF THE INVENTION

The main object of the present invention is to provide a pneumatic tool for users to change rotation direction of the pneumatic motor with single hand.

Another main object of the present invention is to optimize structure of pneumatic tool so as to enhance the structure and reduce the service cost.

To achieve the above and other objects, the pneumatic tool having pendulum-like direction switching mechanism of the present invention includes a pneumatic motor, a control valve, a switching device and a coupling mechanism.

The pneumatic motor includes a cylinder and a rotor. The rotor is rotatably disposed in the cylinder, and the cylinder defines two air passages. The cylinder is adapted for pressurized air to be input therein via one of the air passages so as to rotate the rotor.

The control valve rotates between a clockwise rotation position and a counterclockwise rotation position. The control valve is connected to one of the air passages when the control valve locates at the clockwise rotation position, and the control valve is connected to the other one of the air passages when the control valve locates at the counterclockwise rotation position. The control valve is adapted for a pressurized air supplier to connect thereto so as to lead air into the air passage that connects to the control valve.

The switching device includes a first end and a second end, the switching device is generally arc-shaped between the first end and second end. The switching device slides along an arc-shaped route between a first position and a second position. The first end protrudes outwardly from one side of the pneumatic tool when the switching device locates at the first position, and the second end protrudes outwardly from an opposite side of the pneumatic tool when the switching device locates at the second position.

The coupling mechanism connects the switching device to the control valve, and induces the switching device and the control valve to achieve an operation relationship. The control valve locates at the clockwise rotation position when the switching device locates at the first position. The control valve locates at the counterclockwise rotation position when the switching device locates at the second position.

Accordingly, the pneumatic tool having pendulum-like direction switching mechanism of the present invention is constructed with a switching device that can slide along an arc-shaped route, so that protrusion portion of the switching device is minimized. Unexpected shifting by collision is avoided or lessened. Possibilities of damage are also reduced so as to prolong lifetime of the present invention. Furthermore, the arc-shaped route of the switching device extends around the cylinder, and the switching device is approaching to the pneumatic motor. Stability of the structure of the present invention is then enhanced.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing showing a first embodiment of the present invention;

FIG. 2 is a partial breakdown drawing showing a first embodiment of the present invention;

FIG. 2A is a stereogram showing a transmitter of a first embodiment of the present invention;

FIG. 2B is a stereogram showing a pawl of a first embodiment of the present invention;

FIG. 3 is a stereogram showing pneumatic motor of a first embodiment of the present invention;

FIG. 4 is a partial profile showing a first embodiment of the present invention;

FIG. 5 is another partial profile showing a first embodiment of the present invention;

FIGS. 6 and 7 are diagrams showing operation condition of a first embodiment of the present invention;

FIGS. 8 and 9 are diagrams showing operation condition of a second embodiment of the present invention;

FIGS. 10 and 11 are diagrams showing operation condition of a third embodiment of the present invention;

FIGS. 12 and 13 are diagrams showing operation condition of a forth embodiment of the present invention.

### DETAILED DESCRIPTION OF THE PREFERRED EMBODIMENTS

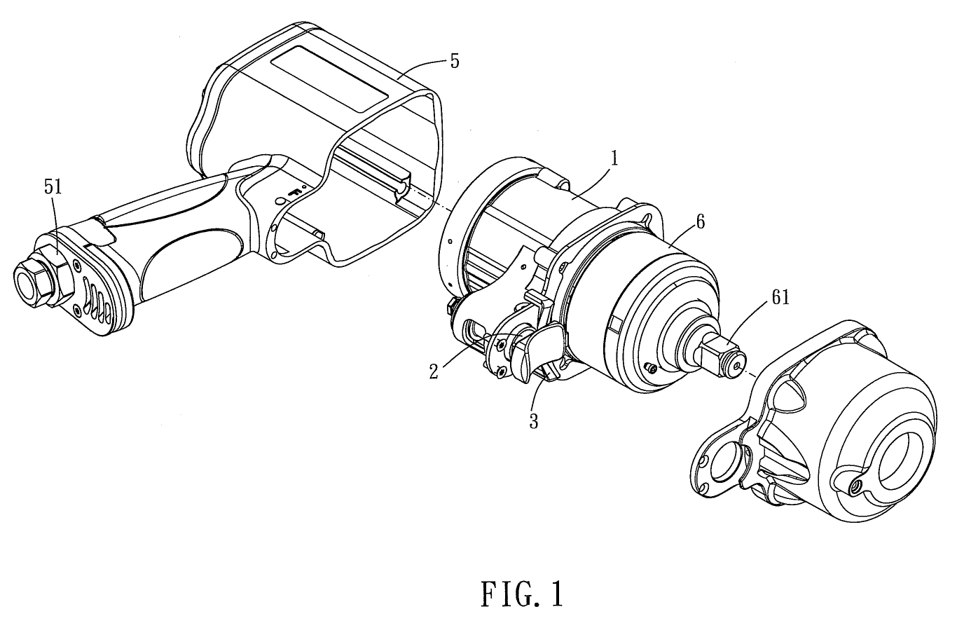

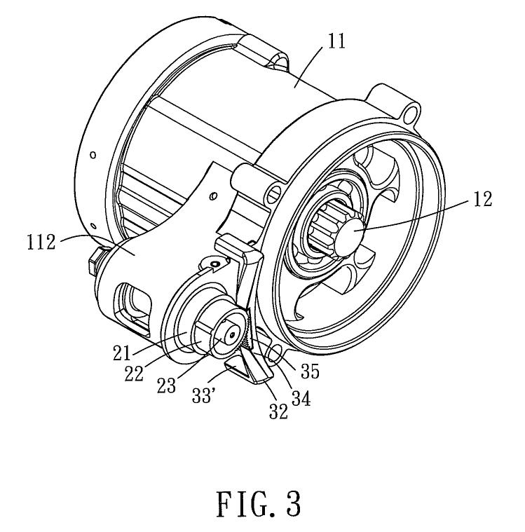

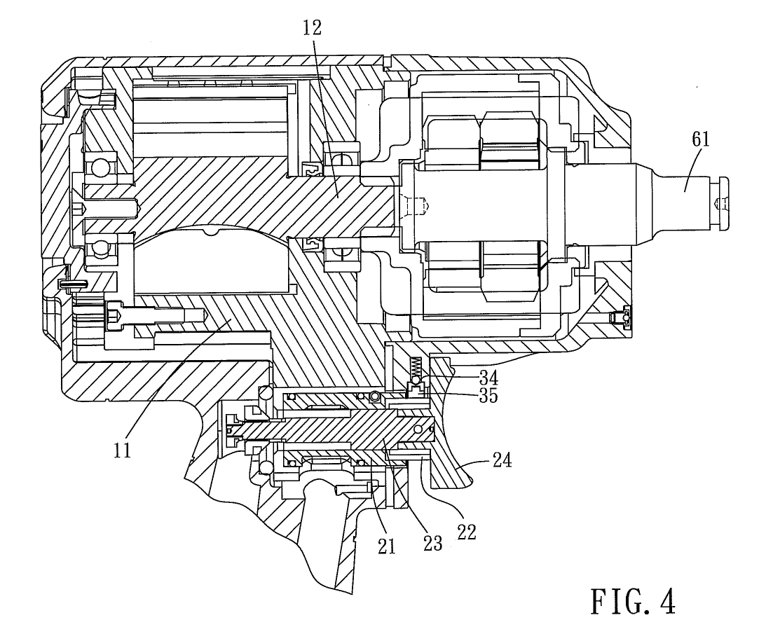

Please refer to FIG. 1 to FIG. 5 for a first embodiment of the present invention. The pneumatic tool having pendulum-like direction switching mechanism of the present embodiment includes a pneumatic motor 1, a control valve 2, a switching device 3, and a coupling mechanism. Preferably, the pneumatic tool may further include a shell 5 and an impact tool 6.

The pneumatic motor 1 includes a cylinder 11 and a rotor 12. The rotor 12 is disposed rotatably in the cylinder 11, and the cylinder 11 defines two air passages 111 and 111′. The cylinder 11 is adapted for pressurized air to be input therein via one of the air passages 111 and 111′ so as to drive the rotor 12 to rotate. Furthermore, the cylinder 11 is formed with an extended portion 112, and the extended portion 112 can be formed with a groove 113. The two air passages 111 and 111′ extend to communicate with the groove 113. Besides, the cylinder 11 may define an exhaust passage for air to release after rotating the rotor 12.

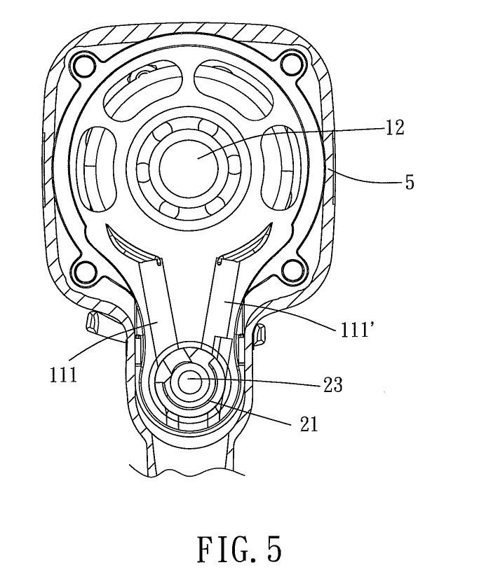

The control valve 2 is disposed rotatably in the groove 113 so as to rotate between a clockwise rotation position and a counterclockwise rotation position. As shown in FIG. 5, the control valve 2 connects to one of the air passages 111 when the control valve 2 locates at the clockwise rotation position. The control valve 2 connects to the other one of the air passages 111′ when the control valve 2 locates at counterclockwise rotation position. The control valve 2 connects to a pressurized air supplier to lead air into the air passage 111 or 111′. The control valve 2 is able to rotate and alternatively switch between the two air passages 111 and 111′ so as to determine rotation direction of the rotor 12. In the present embodiment, the control valve 2 includes a tube 21 and a transmitter 22. The tube 21 is disposed rotatably in the groove 113. The tube 21 sleeves on the transmitter 22. The transmitter 22 and the tube 21 have cross-sections corresponding to each other so as to achieve an operation relationship. More particularly, one of the transmitter 22 and the tube 21 is formed with a groove 211, and the other one is formed with a corresponding protruding rib 221 to be received in the groove 211. Thus, the transmitter 22 can rotate together with the tube 21. The control valve 2 further includes an actuating valve rod 23 and a pressing button 24. The actuating valve rod 23 is disposed slidably in the tube 21 so as to close the tube 21 selectively, determining whether to receive air. The pressing button 24 is disposed stably on an end of the actuating valve rod 23 for users to press to open the tube 21 and lead air in.

The switching device 3 includes a first end 31 and a second end 32. The switching device 3 is generally arc-shaped between the first end 31 and the second end 32, and the switching device 3 slides along an arc-shaped route between a first position and a second position. Preferably, the arc-shaped route of the switching device extends around the cylinder 11, and the switching device 3 is disposed slidably on the shell 5. The first end 31 protrudes outwardly from one side of the pneumatic tool when the switching device 3 locates at the first position. The second end 32 protrudes outwardly from an opposite side of the pneumatic tool when the switching device 3 locates at the second position. In the present embodiment, the switching device 3 is formed with two pressing portions 33 and 33′. Each of the pressing portions 33 and 33′ is enlarged for manual pressing. One of the pressing portions 33 locates at the first end 31, and the other pressing portion 33′ locates at the second end 32.

The coupling mechanism connects the switching device 3 to the control valve 2 so as to achieve an operation relationship and drive the control valve 2 to rotate when the switching device 3 slides along the arc-shaped route.

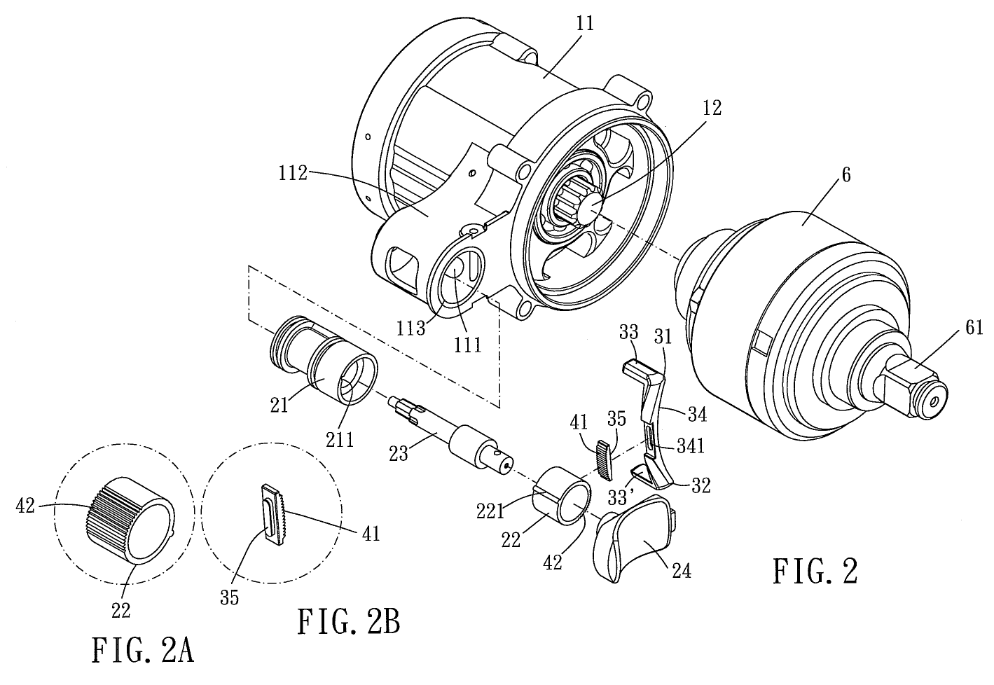

In the present embodiment, the coupling mechanism includes a first toothed portion 41 and a second toothed portion 42. The first toothed portion 41 is formed on the switching device 3, and the second toothed portion 42 is formed on the control valve 2. The first toothed portion 41 mates with the second toothed portion 42. The control valve 2 rotates together with the switching device 3 when the switching device 3 slides along the arc-shaped route. As shown in FIG. 2 and FIG. 2A, the second toothed portion 42 is formed on the transmitter 22. As shown in FIG. 2 and

FIG. 2B, the switching device 3 includes an arc-shaped rod 34 and a pawl 35. On center of the rod 34 is formed with a positioning groove 341. The pawl 35 is further formed with the first toothed portion 41. The pawl 35 is received in the positioning groove 341 and abuts against the rod 34 so as to achieve an operation relationship with the rod 34. In other words, the pawl 35 would slide together with the rod 34.

With the mechanism mentioned above, lifetime of the switching device is prolonged. The switching device 3 is operated for controlling the control valve 2. By reciprocating the switching device 3 again and again, the coupling mechanism between the switching device 3 and the control valve 2 would be abraded and damaged seriously. It is contributed that the switching device 3 includes the rod 34 and the pawl 35. The pawl 35 may be made by wear-resistant material so as to minimize the abrasion. In addition, repair and service cost can be reduced since the pawl 35 may be renew without exchanging the total switching device 3. Old rod 34 may be kept and be assembled with new pawl 35 after reparation. Similar functions can be provided by the tube 21 and the transmitter 22 of the control valve 2, also.

The pneumatic motor 1 and the control valve 2 are disposed stably in the shell 5, and the switching device 3 is disposed slidably on the shell 5. The switching device 3 protrudes outwardly from two sides of the shell 5 to be provided for users to switch direction directly. The shell 5 may be assembled from several parts. Another control valve 51 can be disposed on the shell 5 so as to be connected to the air supplier and to control flow rate of pressurized air.

The impact tool 6 is disposed rotatably in the shell 5. The impact tool 6 is connected to the rotor 12 and has an operation head 61. The rotor 12 drives the impact tool to rotate, so that rotation power is transmitted by the operation head 61.

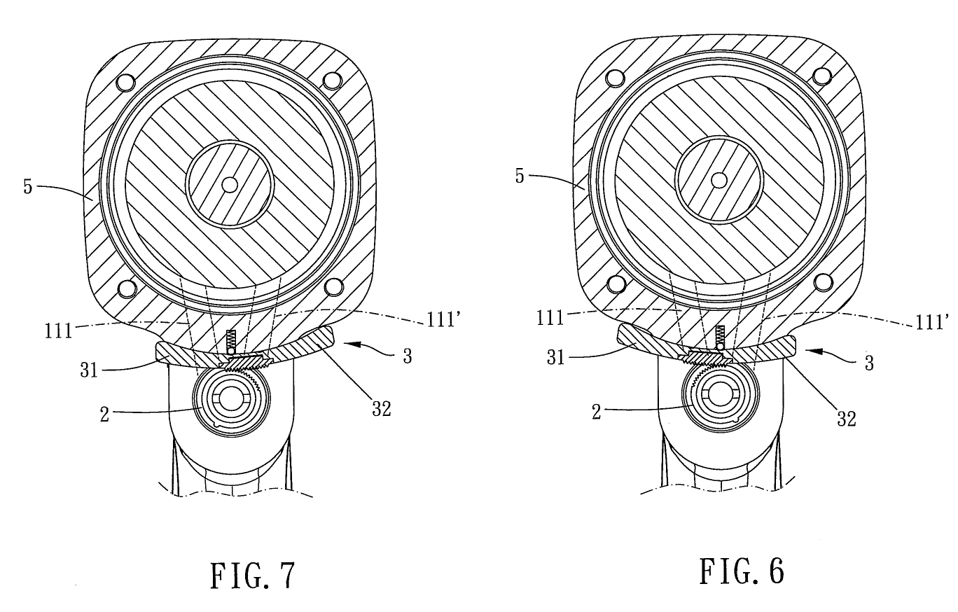

Accordingly, please refer to FIG. 6 and FIG. 7, the switching device 3 is provided for users to switch direction from the outside of the shell 5, and the coupling mechanism operates the control valve 2 to rotate when the switching device slides. As shown in FIG. 6, the first end 31 protrudes outwardly from one side of the pneumatic tool when the switching device 3 locates at the first position. The coupling mechanism operates the control valve 2 to rotate to the clockwise rotation position, and lead air into one of the air passages 111. Please refer to FIG. 7, the second end 32 protrudes outwardly from the opposite side of the pneumatic tool when the switching device 3 locates at the second position. The coupling mechanism operates the control valve 2 to rotate to the counterclockwise rotation position, and lead air into the other one of the air passages 111′. The switching device 3 rotates the control valve 2 to change the route through which pressurized air flows into the pneumatic motor 1, changing rotation direction of the rotor 12.

The, switching device slides along the arc-shaped route. Preferably, the switching device rotates about the cylinder so that motion of the switching device simulates motion of a pendulum. Thus, the switching device would approach to the cylinder or the shell without excessively exceeding from the shell. Thus, accidental strikes and possibilities of damage are reduced. Structure strength is then strengthened and lifetime of the pneumatic tool is then prolonged.

Furthermore, users can use the pneumatic tool stably and easily since unexpected strikes, which change rotation direction of the pneumatic tool accidentally, is decreased.

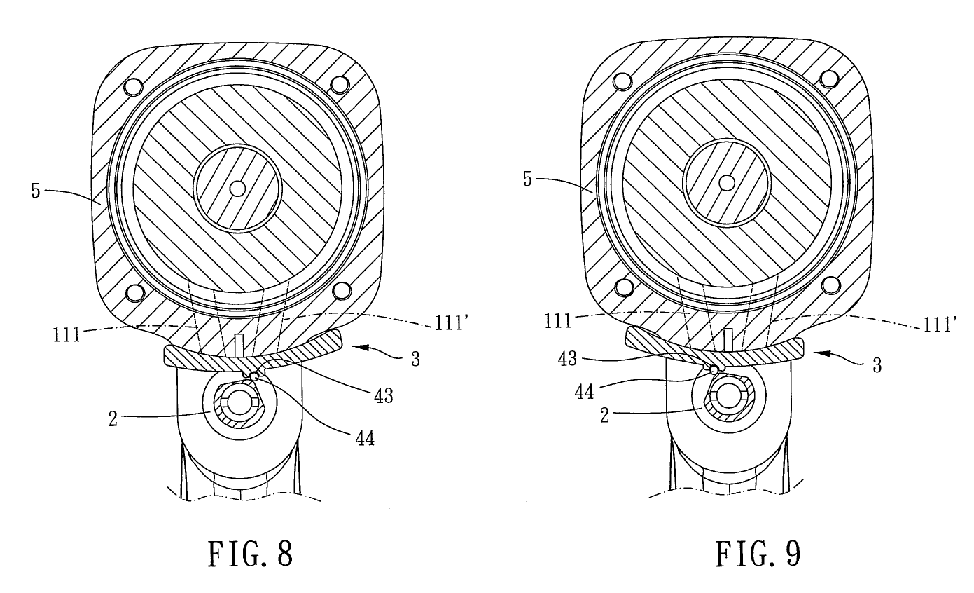

In other embodiments of the present invention, the coupling mechanism can be constructed in other structure. As shown in FIG. 8 and FIG. 9, in the second embodiment of the invention, the coupling mechanism includes a buckle groove 43 and a bolt 44. The buckle groove 43 is formed on the switching device 3, and the bolt 44 is disposed on the control valve 2. In some possible embodiments of the invention, the bolt 44 may be rotatably inserted on the tube or the transmitter, or the bolt 44 may be integrally formed on the control valve 2. The bolt 44 is received in the buckle groove 43. The switching device 3 drives the control valve 2 to rotate by the buckle groove 43 and the bolt 44 when the switching device 3 slides along the arc-shaped route.

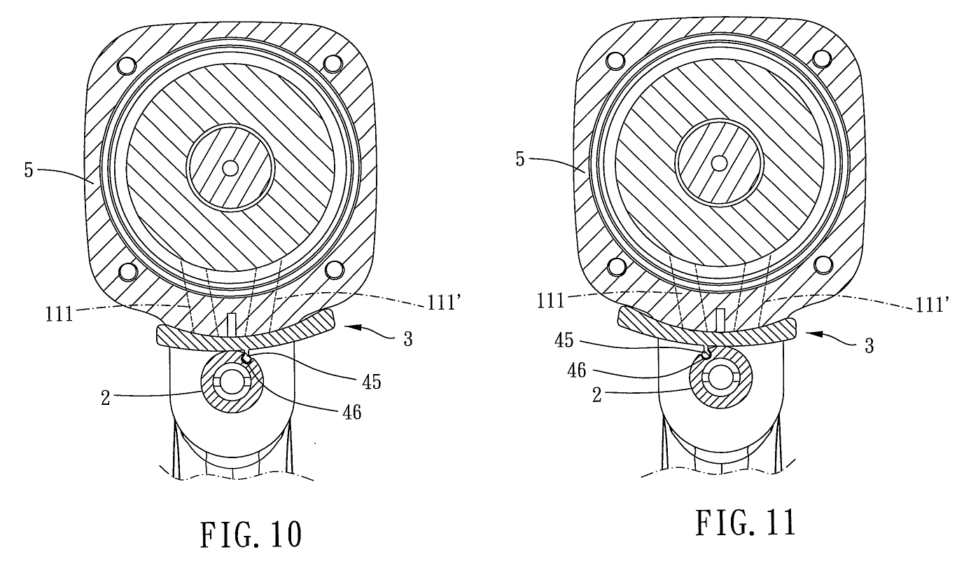

Please refer to FIG. 10 and FIG. 11, in the third embodiment of the invention, the coupling mechanism includes a convex portion 45 and a buckle groove 46. The convex portion 45 is formed on and protrudes downwardly from the switching device 3. The buckle groove 46 is formed on the control valve. Similarly and alternatively, the buckle groove 46 may be formed on the tube or the transmitter of the control valve 2. The convex portion 45 is rotatably received in the buckle groove 46, so that the switching device 3 can drive the control valve 2 to rotate when it slides.

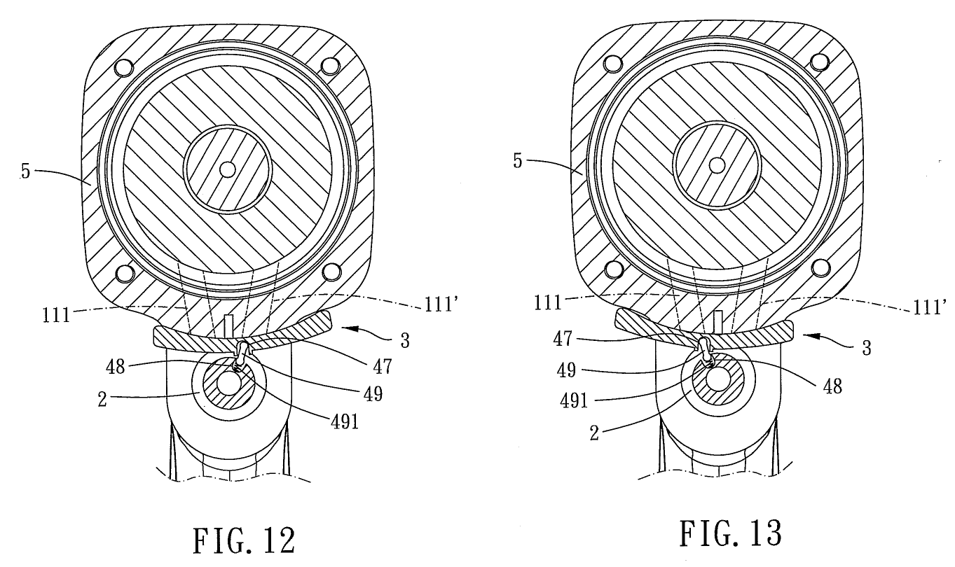

Please refer to FIG. 12 and FIG. 13, in the fourth embodiment of the invention, the coupling mechanism includes a first buckle groove 47, a second buckle groove 48 and a turning lever 49. Preferably, an elastic member 491 is also included in. The first buckle groove 47 is formed on the switching device 3, and the second buckle groove 48 is formed on the control valve 2. Two ends of the turning lever 49 are rotatably received in the first buckle groove 47 and the second buckle groove 48, respectively. The switching device 3 slides to drive the control valve 2 to rotate by the first buckle groove 47, the turning lever 49, and the second buckle groove 48. Two ends of the turning lever 49 may be formed with enlarged ends so as to be received in first buckle groove and second buckle groove, avoiding the center thereof getting stuck with the grooves so as to smoothen motion of the coupling mechanism. The elastic member 491 can be disposed between the turning lever 49 and the control valve 2, pushing the turning lever 49 toward the switching device to enhance the fitness of the components. Alternatively, that the elastic member 491 is disposed between the turning lever 49 and the switching device 3 is also effective.

To conclude, the pneumatic tool is provided with the switching device 3 for users to press. The switching device 3 slides along an arc-shaped route to drive the control valve 2 to rotate and change rotation direction of the rotor. The switching device 3 slides along an arc-shaped route to decrease possibilities of damage and enhance the stability of the structure. Operational property is optimized, and lifetime is prolonged.

What is claimed is:

1. A pneumatic tool having pendulum-like direction switching mechanism, comprising:
a pneumatic motor, comprising a cylinder and a rotor, the rotor being rotatably disposed in the cylinder, the cylinder defining two air passages, the cylinder being adapted for pressurized air to be input therein via one of the air passages so as to rotate the rotor;
a control valve, being rotatable between a clockwise rotation position and a counterclockwise rotation position, the control valve connecting to one of the air passages when the control valve locates at the clockwise rotation position, the control valve connecting to the other one of the air passages when the control valve locates at the counterclockwise rotation position, the control valve being adapted for an air supplier to connect thereto so as to lead air into the air passage connected to the control valve;
a switching device, having a first end and a second end, the switching device being generally arc-shaped between the first end and the second end, the switching device being slidable along an arc-shaped route between a first position and a second position, the first end protruding outwardly from one side of the pneumatic tool when the switching device locates at the first position, the second end protruding outwardly from an opposite side of the pneumatic tool when the switching device located at the second position;
a coupling mechanism, connecting the switching device to the control valve, inducing the switching device and the control valve to achieve an operation relationship;
wherein the control valve locates at the clockwise rotation position when the switching device locates at the first position;
wherein the control valve locates at the counterclockwise rotation position when the switching device locates at the second position.

2. The pneumatic tool having pendulum-like direction switching mechanism of claim 1, wherein the arc-shaped route of the switching device extends around the cylinder.

3. The pneumatic tool having pendulum-like direction switching mechanism of claim 1, wherein the coupling mechanism comprises a first toothed portion and a second toothed portion, the first toothed portion is formed on the switching device, the second toothed portion is formed on the control valve, and the first toothed portion is mated with the second toothed portion.

4. The pneumatic tool having pendulum-like direction switching mechanism of claim 3, wherein the switching device comprises an arc-shaped rod and a pawl, on center of the rod is formed with a positioning groove, the pawl is formed with the first toothed portion, and the pawl is received in the positioning groove and abuts against the rod so as to achieve an operation relationship with the rod.

5. The pneumatic tool having pendulum-like direction switching mechanism of claim 4, wherein the rod and the pawl are made from different materials.

6. The pneumatic tool having pendulum-like direction switching mechanism of claim 3, wherein the control valve comprises a rotatable tube and a transmitter, the tube sleeves on the transmitter, the transmitter is rotatable together with the tube, and the second toothed portion is formed on the transmitter.

7. The pneumatic tool having pendulum-like direction switching mechanism of claim 1, wherein the switching device is formed with two pressing portions, each pressing portion is enlarged for manual pressing, one of the pressing portions is located at the first end, and the other pressing portion is located at the second end.

8. The pneumatic tool having pendulum-like direction switching mechanism of claim 2, wherein the switching device is formed with two pressing portions, each pressing portion is enlarged for manual pressing, one of the pressing portions is located at the first end, and the other pressing portion is located at the second end.

9. The pneumatic tool having pendulum-like direction switching mechanism of claim 3, wherein the switching device is formed with two pressing portions, each pressing portion is enlarged for manual pressing, one of the pressing portions is located at the first end, and the other pressing portion is located at the second end.

10. The pneumatic tool having pendulum-like direction switching mechanism of claim 4, wherein the switching device is formed with two pressing portions, each pressing portion is enlarged for manual pressing, one of the pressing portions is located at the first end, and the other pressing portion is located at the second end.

11. The pneumatic tool having pendulum-like direction switching mechanism of claim 5, wherein the switching device is formed with two pressing portions, each pressing portion is enlarged for manual pressing, one of the pressing portions is located at the first end, and the other pressing portion is located at the second end.

12. The pneumatic tool having pendulum-like direction switching mechanism of claim 6, wherein the switching device is formed with two pressing portions, each pressing portion is enlarged for manual pressing, one of the pressing portions is located at the first end, and the other pressing portion is located at the second end.

13. The pneumatic tool having pendulum-like direction switching mechanism of claim 1, wherein the pneumatic tool further comprises a shell, the pneumatic motor is stably disposed in the shell, and the switching device is slidably disposed on the shell.

14. The pneumatic tool having pendulum-like direction switching mechanism of claim 2, wherein the pneumatic tool further comprises a shell, the pneumatic motor is stably disposed in the shell, and the switching device is slidably disposed on the shell.

15. The pneumatic tool having pendulum-like direction switching mechanism of claim 5, wherein the pneumatic tool further comprises a shell, the pneumatic motor is stably disposed in the shell, and the switching device is slidably disposed on the shell.

16. The pneumatic tool having pendulum-like direction switching mechanism of claim 7, wherein the pneumatic tool further comprises a shell, the pneumatic motor is stably disposed in the shell, and the switching device is slidably disposed on the shell.

17. The pneumatic tool having pendulum-like direction switching mechanism of claim 13, wherein the pneumatic tool further comprises an impact tool, the impact tool is rotatably disposed in the shell, the impact tool is connected to the rotor so as to be rotated by the rotor.

18. The pneumatic tool having pendulum-like direction switching mechanism of claim 14, wherein the pneumatic tool further comprises an impact tool, the impact tool is rotatably disposed in the shell, the impact tool is connected to the rotor so as to be rotated by the rotor.

19. The pneumatic tool having pendulum-like direction switching mechanism of claim 15, wherein the pneumatic tool further comprises an impact tool, the impact tool is rotatably disposed in the shell, the impact tool is connected to the rotor so as to be rotated by the rotor.

20. The pneumatic tool having pendulum-like direction switching mechanism of claim 16, wherein the pneumatic tool further comprises an impact tool, the impact tool is rotatably disposed in the shell, the impact tool is connected to the rotor so as to be rotated by the rotor.
